(19) United States
(12) Patent Application Publication
(10) Pub. No.: US 2010/0132975 A1
(43) Pub. Date: Jun. 3, 2010

(54) INSULATED ELECTRICAL WIRE, ELECTRICAL COIL, AND MOTOR

(76) Inventors: Toru Shimizu, Osaka-shi (JP); Masaaki Yamauchi, Osaka-shi (JP); Akira Mizoguchi, Osaka-shi (JP); Masahiro Koyano, Kouka-shi (JP); Hideaki Ito, Kouka-shi (JP)

Correspondence Address: MCDERMOTT WILL & EMERY LLP, 600 13TH STREET, N.W., WASHINGTON, DC, 20005-3096, US

(21) Appl. No.: 12/595,559

(22) PCT Filed: Apr. 7, 2008
(86) PCT No.: PCT/JP2008/056885

§ 371 Date: Jan. 19, 2010

(30) Foreign Application Priority Data
Apr. 12, 2007 (JP) 2007 105122

(51) Int. Cl. H01B 3/30

(52) U.S. Cl. 174/110 SR

(57) ABSTRACT

Provided is an insulated electrical wire having an insulating coating that is relatively inexpensive, has good mechanical strengths such as hardness and good thermosoftening resistance, and exhibits a high corona discharge inception voltage. The insulated electrical wire comprises a conductor and an insulating coating which covers the conductor, and the insulating coating includes an insulating layer formed by applying and baking a mixed resin of a polyetherimide and a polyesterimide. In particular, the mixing ratio (weight ratio) of the polyesterimide to the polyetherimide is 75:25 to 10:90. An electrical coil produced by winding the insulated electrical wire and a motor comprising the electrical coil are also provided.

### TECHNICAL FIELD

The present invention relates to insulated electrical wires for use as winding wires for coils, and, in particular, to an insulated electrical wire having an insulating coating with a high partial discharge (corona discharge) inception voltage. The present invention also relates to an electrical coil formed by winding the insulated electrical wire and a motor that uses the electrical coil.

### BACKGROUND ART

In recent years, there has been an increasing number of electrical appliances having a high application voltage, such as motors and the like. Application of high voltage causes partial discharge (corona discharge) to readily occur on a surface of an insulating coating of an insulated electrical wire constituting the electrical appliance, for example, a winding wire for a coil of a motor or the like. Occurrence of corona discharge induces a local increase in temperature and generation of ozone and ions, and this results in problems such as damage to the insulating coating, early dielectric breakdown, and shortening of the lifetime of insulated electrical wires and eventually the electrical appliances.

In an insulated electrical wire used as a winding wire for coils of motors and the like, the insulating coating that covers a conductor (conductive wire) is required to exhibit good insulating property, good adhesiveness to the conductor, high thermosoftening resistance, high mechanical properties, etc. However, for the above-described reasons, the insulating coating is now required to exhibit improved corona discharge inception voltage also.

When small gaps are present in the insulating coating of the insulated electrical wire or between windings of the coil, corona discharge readily occurs due to electrical field concentration at such gaps. Regarding this, Patent Document 1 proposes a method including applying a thermal adhesive resin onto an outer layer of an insulating layer formed on a conductor, baking the applied resin, winding the resultant wire, and thermally adhering the wound wire. As a result of thermal adhesion, air layers between the windings of the insulated electrical wire can be buried, and the corona discharge inception voltage can thereby be improved.

Patent Document 2 proposes an insulated electrical wire in which a conductive layer having a particular surface resistance (1 KΩ to 1 MΩ) is formed on an outer layer of an insulating layer formed on a conductor. Patent Document 3 proposes formation of a semiconducting layer by applying a semiconductor material, such as carbon black, on an outer layer of an insulating layer formed on a conductor. When such a conductive layer or a semiconducting layer is formed, the static potential gradient occurring on the surface of the insulating coating becomes gentle and the corona discharge inception voltage can be improved.

Patent Document 1: Japanese Unexamined Patent Application Publication No. 10-261321

Patent Document 2: Japanese Unexamined Patent Application Publication No. 2004-254457

Patent Document 3: Japanese Unexamined Patent Application Publication No. 2-189814

### DISCLOSURE OF THE INVENTION

### Problems to be Solved by the Invention

However, there is a problem with the method described in Patent Document 1 in that the thermal adhesion step is needed after the wire-winding operation.

According to the methods described in Patent Documents 2 and 3, although the corona discharge inception voltage improves, the surface resistance of the insulated electrical wire decreases due to the presence of the conductive layer or the semiconducting layer and the leakage electrical current flowing in the surface of the electrical wire during AC carrying increases. This leads to a problem of deterioration of the surface of the insulated electrical wire due to generation of heat. Moreover, since short circuiting may occur between a conductor-exposed portion at an end of the insulated electrical wire and the conductive layer (or the semiconducting layer) on the surface of the insulated electrical wire, a problem arises in that a step of removing the conductive layer or semiconducting layer at the end of the insulated electrical wire becomes necessary.

One known way of improving the corona discharge inception voltage is to decrease the dielectric constant of the insulating coating. Polyimide resins and fluororesins are known as insulating materials having low dielectric constants.

Polyimide resins are favorable materials since they have a low dielectric constant, mechanical strengths, such as hardness, required for the insulating coating, and thermosoftening resistance that prevents softening even in a high-temperature environment, but are expensive and increase the cost, which poses a problem. In contrast, fluororesins are not suitable for forming the insulating coatings for winding wires since they are soft and have low thermosoftening temperature and mechanical strength although their dielectric constant is low.

The present invention has been made to address the problems described above. An object thereof is to provide an insulated electrical wire having an insulating coating that is relatively inexpensive, has good mechanical strengths such as hardness and good thermosoftening resistance that prevents softening even in a high-temperature environment, and exhibits a high corona discharge inception voltage.

### Means for Solving the Problems

The inventor of the present invention has conducted extensive studies to solve the problems and found that when an insulating layer is formed by applying and baking a resin composition containing a mixed resin of a polyetherimide and a polyesterimide, an insulating coating that has not only a low dielectric constant and a high corona discharge inception voltage, but also good mechanical strengths such as hardness, and good thermosoftening resistance that prevents softening even in a high-temperature environment can be obtained. Thus, the present invention has been made.

The present invention provides the following as claim 1:

An insulated electrical wire comprising a conductor and an insulating coating that covers the conductor, wherein the insulating coating includes an insulating layer formed by applying and baking a mixed resin of a polyetherimide and a polyesterimide.

The inventor of the present invention has found that when the polyetherimide and the polyesterimide are mixed with each other, the dielectric constant can be made lower and the corona discharge inception voltage can be made higher than when they are used alone without hampering the mechanical strength and the thermosoftening resistance of the respective resins.

The mixing ratio (weight ratio) of the polyesterimide to the polyetherimide in the mixed resin described above is preferably in the range of 75:25 to 10:90 (claim 2). A lower dielectric constant and a higher corona discharge inception voltage can be obtained within this range. When the mixing ratio of the polyesterimide is greater than 75:25, there is a problem that the dielectric constant increases and the corona discharge inception voltage decreases. When the mixing ratio of the polyetherimide is greater than 10:90, the dielectric constant may increase and the heat resistance may decrease. In order to achieve a particularly high corona discharge inception voltage, the range of 30:70 to 20:80 is more preferable.

A polyetherimide represented by general formula (1) below is preferably used as the polyetherimide.

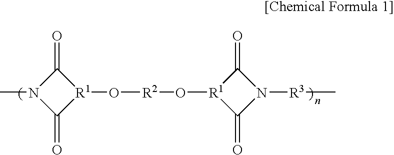

In the formula, R¹ represents an organic group such as a residue of a hydroxyl-containing dicarboxylic anhydride, R² represents a divalent organic group such as a residue of a diol, R³ represents a divalent organic group such as a residue of a diamine, and n represents an integer.

Examples of the polyetherimide represented by general formula (1) above include aromatic polyetherimides produced by a known method using aromatic bis(ether anhydride) and organic diamino compounds as starting materials. Examples of the aromatic bis(ether anhydride) include 1,3-bis(2,3-dicarboxyphenoxy)benzene dianhydride, 4,4′-bis(3,4-dicarboxyphenoxy)diphenyl ether dianhydride, bis[4-(3,4-dicarboxyphenoxy)-phenyl]methane dianhydride, 2,2′-bis[4-(3,4-dicarboxyphenoxy)-phenyl]propane dianhydride, and 1,5-bis(3,4-dicarboxyphenoxy)naphthalene.

Examples of the organic diamino compounds include m-phenylenediamine, p-phenylenediamine, 4,4′-diaminodiphenyl ether, 4,4′-diaminodiphenyl methane, 4,4′-diaminodiphenyl propane, and 1,5-diaminonaphthalene. An example of the polyetherimide is a product synthesized by solution polycondensation of 2,2′-bis[4-(3,4-dicarboxyphenoxy)-phenyl]propane dianhydride and 4,4′-diaminodiphenyl methane with ortho-dichlorobenzene as the solvent.

As the polyetherimide, commercially available products such as Ultem 1000, 2000, 4000, 5000, and 6000 (trade name) produced by Japan G E. Plastic Co., Ltd., may be used.

A polyesterimide represented by general formula (2) below is preferably used as the polyesterimide.

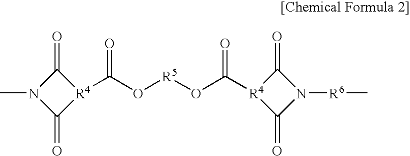

In the formula, R⁴ represents a trivalent organic group such as a residue of a tricarboxylic anhydride, R⁵ represents a divalent organic group such as a residue of a diol, and R⁶ represents a divalent organic group such as a residue of a diamine.

The polyesterimide varnish is obtained by reacting a tricarboxylic anhydride, a diol, and a diamine by a known method. Examples of the tricarboxylic anhydride include trimellitic anhydride, 3,4,4′-benzophenone tricarboxylic anhydride, and 3,4,4′-biphenyl tricarboxylic anhydride. Among these, trimellitic anhydride is preferred.

Examples of the diol preferably used include ethylene glycol, propylene glycol, trimethylene glycol, and diethylene glycol.

Examples of the diamine preferably used include 4,4′-diaminodiphenyl methane, 4,4′-diaminodiphenyl ether, m-phenylenediamine, p-phenylenediamine, 1,4-diaminonaphthalene, hexamethylenediamine, and diaminodiphenyl sulfone.

Commercially available products such as ISOMID 40SM-45 and 40HA-45 (trade name) produced by Hitachi Chemical Co., Ltd., and Neoheat 8645H2 and 8645AY (trade name) produced by Totoku Toryo Co., Ltd., can be used as the polyesterimide.

The insulated electrical wire of the present invention can be obtained by applying a varnish of a mixed resin of a polyetherimide and a polyesterimide onto a conductor or another resin layer formed on the conductor, and performing baking. The mixed resin varnish is obtained by adding a polyetherimide resin weighed to achieve a particular resin mixing ratio into a polyesterimide varnish and stirring and mixing the resultant mixture. Since a mixed resin varnish can be obtained by an extremely simple process such as stirring and mixing, an increase in cost is prevented, which is preferable.

If needed, various additives such as a dye, a pigment, an organic or inorganic filler, and a lubricant may be added to the resulting mixed resin varnish. Moreover, if needed, heating may be conducted after adding the additives. A resin other than the polyetherimide and the polyesterimide may be blended as long as the essence of the present invention is not impaired.

The conditions of application and baking are the same as those employed when an insulating layer is formed by applying a common polyamideimide resin varnish or the like onto a conductor and conducting baking. The thickness of the insulating coating is determined by considering the extent of the physical property required for the insulated electrical wire, the diameter of the conductor, etc.

Representative examples of the conductor are copper or copper alloy wires; however, the conductor may be a wire of other metals, such as silver. The diameter and the cross-sectional shape of the conductor are not particularly limited.

The insulating coating of the insulated electrical wire of the present invention may be a coating (single coating) constituted by only an insulating layer formed by applying and baking a mixed resin of a polyetherimide and a polyesterimide but may include another resin layer above and/or below the insulating layer in addition to that insulating layer. For example, the insulating coating preferably further includes a resin layer mainly composed of a polyamideimide, since an insulating coating having higher thermosoftening resistance, mechanical properties, and hydrolysis resistance are obtained (claim 3).

In particular, when a highly adhesive polyamideimide is used as the polyamideimide that forms the innermost layer and an insulating layer composed of a mixed resin of a polyetherimide and a polyesterimide is formed on the innermost layer, an insulating coating having good adhesiveness can be obtained.

Furthermore, a surface lubricating layer which imparts a lubricating property to the surface of the insulating coating may be formed as the outermost layer of the insulating coating (claim 4). For example, a triple-coated insulated electrical wire may be formed by forming a surface lubricating layer as the outermost layer (third layer) on a surface of a double-coated insulated electrical wire that includes the innermost layer composed of a polyamideimide and an insulating layer formed on the innermost layer and composed of a mixed resin of a polyetherimide and a polyesterimide. A coating composed of a paraffin such as a liquid paraffin or a solid paraffin can be used as the surface lubricating layer; however, in view of durability and the like, a surface lubricating layer formed by binding a lubricant, such as a wax, e.g., carnauba wax, beeswax, montan wax, microcrystalline wax, and the like, polyethylene, fluororesin, or silicone resin, with a binder resin is more preferred. In addition, a surface lubricating oil may be provided to enhance an insertion property.

If necessary, a flame-retardant layer or the like may be provided. The insulating layer constituting the outermost layer of the insulating coating may serve as both a flame-retardant layer and a surface lubricating layer by incorporation of a lubricant.

The insulated electrical wire of the present invention is preferable as a winding wire of a coil used in an electric appliance such as a motor. In particular, since the corona discharge inception voltage is high and the dielectric breakdown caused by corona discharge is suppressed, the insulated electrical wire is suitable for use in electric appliances, such as motors, with high application voltage.

Thus, the present invention also provides, in addition to the insulated electrical wire described above, an electrical coil formed by winding the insulated electrical wire as set forth in claim 5, and a motor (claim 6) that uses the electrical coil of claim 5.

### ADVANTAGES

An insulated electrical wire of the present invention includes an insulating coating that has good mechanical strength such as hardness and thermosoftening resistance that prevents softening even in a high-temperature environment and that can be obtained from relatively inexpensive materials. Moreover, the insulating coating has a high corona discharge inception voltage and can suppress occurrence of dielectric breakdown caused by corona discharge. Thus, the insulated electrical wire is suitable for use as a winding wire for a coil used in an electrical appliance such as a motor.

### BRIEF DESCRIPTION OF DRAWINGS

FIG. 1 is a diagram illustrating a method for measuring a dielectric constant.

FIG. 2 is a diagram illustrating a test piece for measuring a corona discharge inception voltage.

### BEST MODES FOR CARRYING OUT THE INVENTION

The best modes for carrying out the invention will now be described by using Examples. It should be understood that the scope of the present invention are not limited to Examples only.

### EXAMPLES

### Preparation of a Mixed Resin Varnish

Prior to fabricating an insulated electrical wire of the present invention, a mixed resin varnish was prepared by a method described below.

### <Polyesterimide Varnish>

ISOMID 40SM-45 (trade name) produced by Hitachi Chemical Co., Ltd. (solid content: 45%) was used as a polyesterimide varnish. The polyesterimide varnish is also referred to as “PEsI” hereinafter.

### <Polyetherimide Varnish>

Into a flask equipped with a thermometer, a condenser tube, a calcium chloride-filled tube, and a stirrer, 800 g of cresol was injected and heated to 130° C. Then 200 g of Ultem 1000 (trade name, a polyetherimide produced by Japan G. E. Plastic Co., Ltd.) was added thereto. The resulting mixture was stirred for 1 hour at 130° C. to dissolve, and a polyetherimide varnish having a density of 20% was obtained as a result. The polyetherimide varnish is also referred to as “PEI” hereinafter.

### (Fabrication of a Mixed Resin Varnish)

Into a flask equipped with a thermometer, a condenser tube, a calcium chloride-filled tube, and a stirrer, a polyesterimide varnish and a polyetherimide varnish are injected at a resin mixing ratio (in solid equivalent on a weight basis) shown in Table I. The resulting mixture was stirred for 1 hour at 130° C. to obtain mixed resin varnishes of Prescription Examples 1 to 7. The solid contents (%) of the resulting mixed resin varnishes are also shown in Table I.

TABLE I

| | | Prescription Examples | | | | | | |
|---|---|---|---|---|---|---|---|---|
| | | 1 | 2 | 3 | 4 | 5 | 6 | 7 |
| Mixing ratio | | 75:25 | 50:50 | 40:60 | 30:70 | 25:75 | 20:80 | 10:90 |
| (PEsI:PEI) | | | | | | | | |
| Added | PEsI | 342.9 | 184.6 | 137.1 | 96.0 | 77.4 | 60.0 | 28.2 |
| amount/g | PEI | 257.1 | 415.4 | 462.9 | 504.0 | 522.6 | 540.0 | 571.8 |

| | | | | | | | |
|---|---|---|---|---|---|---|---|
| Total/g | 600.0 | 600.0 | 600.0 | 600.0 | 600.0 | 600.0 | 600.0 |
| Solid content/% | 34.3 | 27.7 | 25.7 | 24.0 | 23.2 | 22.5 | 21.2 |

### Examples 1 to 3 and comparative examples 1 and 2

### Fabrication of a Single-Coated Insulated Electrical Wire

Mixed resin varnishes of Prescriptive Example Nos. indicated in Table II were respectively applied on surfaces of copper wires having conductor diameters shown in Table II and baked by a common procedure to obtain single-coated insulated electrical wires of Examples 1 to 3. Similarly, single-coated insulated electrical wires were obtained by using PEsI (Comparative Example 1) and PEI (Comparative Example 2) only. The dimensions of the resulting respective insulated electrical wires (finishing diameter and thickness) are also shown in Table II.

### (Method for Measuring a Dielectric Constant)

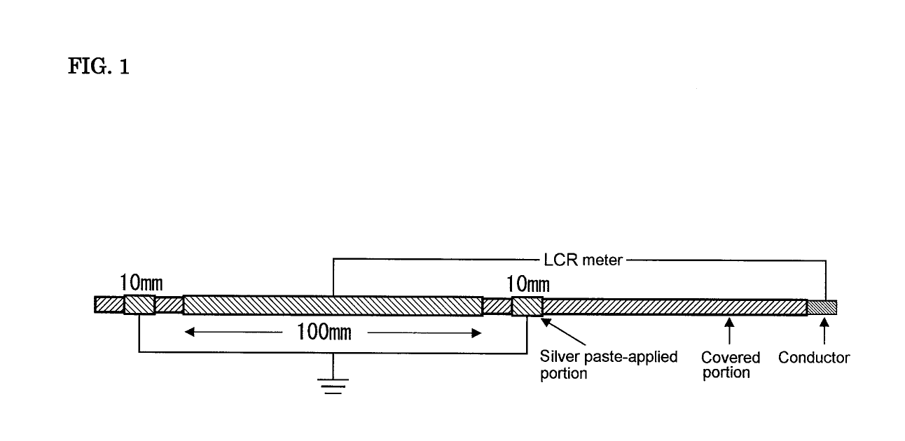

The dielectric constant of each insulated electrical wire obtained was measured. Referring to FIG. 1, the measurement was conducted by applying a silver paste on a surface of a winding wire (application width was 10 mm each at left and right sides and 100 mm for a middle portion), measuring the capacitance between the conductor and the silver paste with an inductance-capacitance-resistance (LCR)) meter, and calculating the dielectric constant from the measured capacitance value and the thickness of the coating. The measurement results are also shown in Table II.

TABLE II

| | | Example 1 | Example 2 | Example 3 | |
|---|---|---|---|---|---|
| | Comparative | Prescription Example No. | | | Comparative |
| | Example 1 | 1 | 2 | 5 | Example 2 |
| PEsI:PEI | 100:0 | 75:25 | 50:50 | 25:75 | 0:100 |
| Thickness/μm | 20.0 | 19.0 | 20.0 | 21.0 | 20.0 |
| Conductor | 1.000 | 0.828 | 0.828 | 0.828 | 0.828 |
| diameter/mm | | | | | |
| Finishing | 1.040 | 0.866 | 0.868 | 0.870 | 0.868 |
| diameter/mm | | | | | |
| Dielectric | 3.6 | 3.5 | 3.5 | 2.9 | 4.1 |
| constant | | | | | |

The results in Table II show that when a mixed resin varnish containing a polyesterimide and a polyetherimide is used, the dielectric constant becomes lower than when a varnish containing only one of them is used.

### Examples 4 to 10 and comparative examples 3 and 4

In this embodiment, mixed resin varnishes of Prescription Examples described above and a general-purpose polyamideimide resin varnish obtained by the method described below were used to form double-coated insulated electrical wires and the corona discharge inception voltage was measured.

### <Method for Making a General-Purpose Polyamideimide Resin Varnish>

Into a flask equipped with a thermometer, a condenser tube, a calcium chloride-filled tube, a stirrer, and a nitrogen-introducing tube, 108.6 g of TMA (a trimellitic anhydride produced by Mitsubishi Gas Chemical Company, Inc.) and 141.5 g of MDI (methylene diisocyanate, trade name: Cosmonate PH produced by Mitsui Takeda Chemical Co, Ltd.) were injected while supplying 150 ml of nitrogen gas per minute from the nitrogen-introducing tube. Then 637.0 g of NMP (N-methyl-2-pyrrolidone solvent produced by Mitsubishi Chemical Corporation) was added, and the resulting mixture was heated at 80° C. for 3 hours under stirring with the stirrer. After the temperature of the system was increased to 140° C. in about 3 hours, the mixture was heated for 1 hour at 140° C. After 1 hour, the heating was ceased and the mixture was cooled to obtain a polyamideimide resin varnish having a nonvolatile content of 25%. This polyamideimide resin varnish is hereinafter referred to as general-purpose AI.

### <Fabrication of Double-Coated Insulated Electrical Wire>

The resulting general-purpose AI was applied on surfaces of copper wires (conductors) with a diameter of about 0.8 mm and baked by a common procedure to form first layers having thicknesses shown in Table III. Mixed resin varnishes of Prescription Example Nos. indicated in Second layer of Resin constitution shown in Tables III and IV were respectively applied on the first layers and baked by a common procedure to form second layers having thicknesses shown in Tables III and IV to thereby obtain double-coated insulated electrical wires of Examples 4 to 10. In addition, a second layer composed of a polyesterimide varnish (Comparative Example 3) only and a second layer composed of a polyetherimide varnish (Comparative Example 4) only are formed to obtain double-coated insulated electrical wires in the same manner. The dimensions (conductor diameter, thickness of each layer, total thickness, and finishing diameter) of each insulated electrical wire are also shown in Tables III and IV.

The corona discharge inception voltage of each resulting insulated electrical wire was measured by the following method.

### (Method for Measuring a Corona Discharge Inception Voltage)

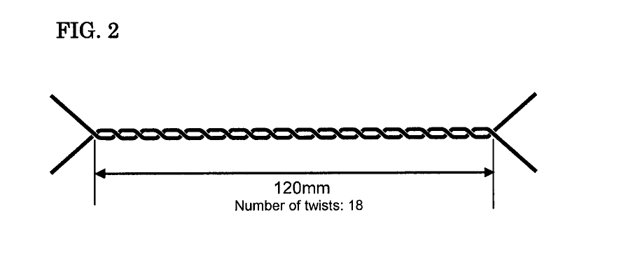

As shown in FIG. 2, two winding wires are twisted and an AC voltage is applied to both ends of the two winding wires. The voltage is increased at a rate of 70 V/sec, and the voltage at which the discharged capacity reaches 100 pC is assumed to be the measured value. The measurement results are also shown in Tables III and IV.

TABLE III

| | | Comparative | | | | |
|---|---|---|---|---|---|---|
| | | Example 3 | Example 4 | Example 5 | Example 6 | Example 7 |
| Resin | First layer | General- | General- | General- | General- | General- |
| constitution | | purpose AI | purpose AI | purpose AI | purpose AI | purpose AI |
| | Second layer | 100:0 | 75:25 | 50:50 | 40:60 | 30:70 |
| | (Prescription | | (1) | (2) | (3) | (4) |
| | Example No.) | | | | | |
| Thickness/ | First layer | 34.0 | 33.5 | 33.5 | 34.0 | 34.0 |
| μm | Second layer | 5.0 | 7.5 | 7.5 | 7.0 | 7.5 |

| | | | | | |
|---|---|---|---|---|---|
| Total Thickness/μm | 39.0 | 41.0 | 41.0 | 41.0 | 41.5 |
| Conductor diameter/mm | 0.830 | 0.828 | 0.828 | 0.820 | 0.820 |
| Finishing diameter/mm | 0.908 | 0.910 | 0.910 | 0.902 | 0.903 |
| Corona discharge | 610 | 635 | 643 | 642 | 645 |
| inception voltage/V | | | | | |

Note that the resin constitution represents PEsI:PEI. For example, in Example 5, 50:50 for Second layer means that the resin varnish contains PEsI and PEI at a weight ratio of 50:50 (solid equivalent). The same applies to tables below.

TABLE IV

| | | | | | Comparative |
|---|---|---|---|---|---|
| | | Example 8 | Example 9 | Example 10 | Example 4 |
| Resin | First layer | General- | General- | General- | General- |
| constitution | | purpose AI | purpose AI | purpose AI | purpose AI |
| | Second layer | 25:75 | 20:80 | 10:90 | 0:100 |
| | (Prescription | (5) | (6) | (7) | |
| | Example No.) | | | | |
| Thickness/ | First layer | 33.5 | 34.0 | 34.0 | 34.0 |
| μm | Second layer | 6.5 | 7.0 | 6.5 | 6.5 |

| | | | | |
|---|---|---|---|---|
| Total thickness/μm | 40.0 | 41.0 | 40.5 | 40.5 |
| Conductor diameter/mm | 0.828 | 0.820 | 0.820 | 0.826 |
| Finishing diameter/mm | 0.908 | 0.902 | 0.901 | 0.907 |
| Corona discharge/V | 673 | 638 | 643 | 632 |
| inception voltage | | | | |

Note that the resin constitution represents PEsI:PEI.

The results in Tables III and IV clearly show that when a mixed resin varnish containing a polyesterimide and a polyetherimide is used, the corona discharge inception voltage becomes higher than when a varnish containing only one of them is used.

### Examples 11 and 12

The mixed resin varnishes obtained as above and a highly adhesive polyamideimide resin varnish described below were used to fabricate triple-coated and quadruple-coated insulated electrical wires and the corona discharge inception voltage was measured.

### (Highly Adhesive Polyamideimide Resin Varnish)

HI400A-25 produced by Hitachi Chemical Co., Ltd., was used as the highly adhesive polyamideimide resin varnish. Hereinafter, this is also referred to as highly adhesive AI.

### <Fabrication of Triple-Coated Insulated Electrical Wire>

The highly adhesive AI was applied onto a surface of a copper wire (conductor) with a diameter of about 0.8 mm and baked by a common procedure to form a first layer having a thickness shown in Table V. The general-purpose AI was applied thereon and baked by a common procedure to form a second layer having a thickness shown in Table V. A mixed resin varnish shown in Third layer of Resin constitution of Table V was applied thereon and baked by a common procedure to form a third layer having a thickness shown in Table V to obtain a triple-coated insulated electrical wire of Example 11.

### <Fabrication of Quadruple-Coated Insulated Electrical Wire>

The general-purpose AI was applied on the triple-coated insulated electrical wire obtained in Example 11 and baked by a common procedure to form a fourth layer having a thickness shown in Table V and to thereby obtain a quadruple-coated insulated electrical wire of Example 12. Another quadruple-coated insulated electrical wire was fabricated which was identical to that of Example 12 except for that the third layer was composed of the general-purpose AI. This electrical wire was used as Comparative Example 5. The dimensions (conductor diameter, thickness of each layer, total thickness, and finishing diameter) of each resulting insulated electrical wire are also shown in Table V.

The corona discharge inception voltage of each resulting insulated electrical wire was measured by the same method described above. The measurement results are shown Table V.

TABLE V

| | | | Comparative | |
|---|---|---|---|---|
| | | Example 11 | Example 5 | Example 12 |
| Resin | First layer | Highly | Highly | Highly |
| constitution | | adhesive AI | adhesive AI | adhesive AI |
| | Second layer | General- | General- | General- |
| | | purpose AI | purpose AI | purpose AI |
| | Third layer | 25:75 | General- | 25:75 |
| | | | purpose AI | |
| | Fourth layer | — | General- | General- |
| | | | purpose AI | purpose AI |
| Thickness/ | First layer | 7.5 | 7.0 | 7.5 |
| μm | Second layer | 25.5 | 25.0 | 25.5 |
| | Third layer | 8.5 | 6.5 | 5.5 |
| | Fourth layer | — | 2.5 | 3.0 |

| | | | |
|---|---|---|---|
| Total thickness/μm | 41.5 | 41.0 | 41.5 |
| Conductor diameter/mm | 0.823 | 0.822 | 0.821 |
| Finishing diameter/mm | 0.906 | 0.904 | 0.904 |
| Corona discharge | 667 | 643 | 673 |
| inception voltage/V | | | |

Note that the resin constitution represents PEsI:PEI.

Results in Table V show that when a mixed resin varnish containing a polyesterimide and a polyether imide is used, the corona discharge inception voltage increases and this tendency is also observed in the triple-coated insulated electrical wire and the quadruple-coated insulated electrical wire having resin layers composed of the highly adhesive AI.

In view of the above, according to the present invention, the corona discharge inception voltage can be increased very simply by mixing a polyesterimide varnish and a polyetherimide varnish.

1. An insulated electrical wire comprising a conductor and an insulating coating that covers the conductor, wherein the insulating coating includes an insulating layer formed by applying and baking a mixed resin of a polyetherimide and a polyesterimide.

2. The insulated electrical wire according to claim 1, wherein a mixing ratio (weight ratio) of the polyesterimide to the polyetherimide in the mixed resin is 75:25 to 10:90.

3. The insulated electrical wire according to claim 1, wherein the insulating coating further includes a resin layer mainly composed of a polyamideimide.

4. The insulated electrical wire according to claim 1, wherein the insulating coating further includes a surface lubricating layer as the outermost layer.

5. An electrical coil produced by winding the insulated electrical wire according to claim 1.

6. A motor comprising the electrical coil according to claim 5.
